(19) United States
(12) Patent Application Publication
(10) Pub. No.: US 2023/0133456 A1
(43) Pub. Date: May 4, 2023

(54) METHODS FOR MODIFYING MASS SPECTRAL DATA ACQUISITION IN REAL TIME

(71) Applicant: Thermo Finnigan LLC, San Jose, CA (US)

(72) Inventors: Jesse D. CANTERBURY, Shoreline, WA (US); Tim STRATTON, Austin, TX (US); William Dana BARSHOP, Sunnyvale, CA (US); Seema SHARMA, San Jose, CA (US)

(21) Appl. No.: 18/049,931

(22) Filed: Oct. 26, 2022

Related U.S. Application Data
(60) Provisional application No. 63/273,404, filed on Oct. 29, 2021.

(51) Int. Cl. H01J 49/00

(52) U.S. Cl. CPC H01J 49/0045; H01J 49/0036

(57) ABSTRACT

A mass spectrometry method comprises: isolating a first portion of a selected primary ion species; generating one or more fragment ion species by fragmenting the isolated first portion of the primary ion species; determining mass-to-charge (m/z) values of the fragment ion species; searching a mass spectral database or a mass spectral library for a compound for which a predicted or observed m/z value of a primary ion species matches the selected primary ion species and for which one or more m/z values of fragment ion species that are predicted or observed to be generated by fragmentation of the matched primary ion species m/z value match determined fragment-ion m/z values; determining a measure of success of the search; and causing a mass spectrometer to perform one or more altered or replacement procedures that override pre-planned default procedures based on the determined measure of success.

### CROSS-REFERENCE TO RELATED APPLICATIONS

The present application claims, under 35 U.S.C. 119(e), the benefit of the filing date and the right of priority to co-pending U.S. Provisional Application No. 63/273,404, filed on Oct. 29, 2021 and titled “Methods for Modifying Mass Spectral Data Acquisition in Real Time”, the disclosure of which is hereby incorporated by reference herein in its entirety. Additionally, the present application is related to commonly-assigned and co-pending U.S. application Ser. No. 17/825,230, filed May 26, 2022 and titled “Mass Spectrometer Utilizing Mass Spectral Database Search for Compound Identification”, said co-pending application hereby incorporated by reference herein in its entirety.

### TECHNICAL FIELD

The present invention relates to mass spectrometers and mass spectrometric analyses.

### BACKGROUND

Mass spectrometry is a well-established technology for analyzing the presence and concentration (or amount) of a wide variety of chemical constituents with high sensitivity. Such studies often employ the well-known technique of tandem mass spectrometry, often referred to as MS/MS or MS2 mass spectrometry, in which particular precursor ions are selected, isolated and fragmented or otherwise reacted (e.g., in a collision cell or a reaction cell), and the reaction-product ions or fragment ions (all of which are referred to as product ions) are mass analyzed in a mass analyzer. The mass analysis generates a record of the intensities of the various fragment-ion or other product-ion species as a function of their mass-to-charge ratio (m/z) values. The MS2 method can be extended by further fragmentation or reaction of selected and isolated first-generation product ion species so as to generate second-generation product ion species, yet further fragmentation or reaction of selected and isolated second-generation product-ion species so as to generate third-generation product-ion species and so on, with possible mass analysis of the resulting product ions of each generation. Such extensions of the tandem mass spectrometry technique are typically referred to an MSn spectrometry, with “n” indicating the number of steps of mass analysis and the number of generations of ions, with the original unfragmented and unreacted ions comprising the first generation.

FIG. 1 is a schematic example of a general system 20 for automatically generating mass spectrometry spectra, as may be employed in conjunction with the methods of the present teachings. Also, apparatuses in accordance with the present teachings include modifications to the general system 20. As illustrated in FIG. 1, a sample 12 of an analyte mixture is provided to a mass spectrometer system 13. Prior to the introduction of sample material 12 to the mass spectrometer 13, the sample material may be passed through an optional chemical separation apparatus 11, such as, without limitation, a liquid chromatograph, a high-performance liquid chromatograph, an ultra-high-performance liquid chromatograph, a size-exclusion chromatograph or a capillary electrophoresis device. If present, the chemical separation apparatus receives and at least partially separates the analyte mixture into individual chemical “fractions” or separates, in accordance with well-known chromatographic principles. The chemical compositions of the various eluting fractions or separates differ from one another as a result of the chromatographic separation. If the sample 12 is fractionated by a chemical separation apparatus 11, the resulting partially-separated chemical fractions of the sample may be transferred to the mass spectrometer 13 at different respective times for mass analysis.

As each sample portion or fraction is received by the mass spectrometer 13, it is ionized by an ionization source 14. The ionization source may produce a plurality of ions comprising a plurality of ion species (i.e., a plurality of precursor ion species) comprising differing charges or masses from each chemical component. Thus, a plurality of ion species of differing respective m/z ratios may be produced for each chemical component, each such component eluting from the chromatograph at its own characteristic time. These various ion species are mass analyzed by a mass analyzer 15 of the mass spectrometer and detected by a detector 16. As a result of this process, the ion species may be appropriately identified according to their various m/z ratios. As illustrated in FIG. 1, the mass spectrometer comprises a mass filter 17 that is operable to select certain subsets of the precursor ion species according to their m/z values and a fragmentation or reaction cell 18 that is operable to fragment or otherwise chemically react (as with reagent molecules or ions) the selected precursor ions, thereby generating a plurality of product ions comprising a plurality of product ion species. The product ions generated by fragmentation or reaction of various selected subsets of precursor ion species are also analyzed by the mass analyzer 15 and its associated detector 16.

Still referring to FIG. 1, one or more programmable processors 19 is/are electronically coupled to the detector 16 of the mass spectrometer and receive/receives the data produced by the detector 16 during chromatographic/mass spectrometric analysis of the sample(s). The one or more programmable processors 19 may comprise a separate stand-alone computer or may simply comprise a circuit board or any other programmable logic device or system of devices operated by either firmware or software. Optionally, the one or more programmable processors 19 may also be electronically coupled to the chromatograph 11, if present, and to other various components of the mass spectrometer, as shown by dashed lines, in order to transmit electronic control signals to one or the other of these instruments so as to control their operation. The nature of such control signals may possibly be determined in response to the data transmitted from the detector to the one or more programmable processors 19 or in response to the analysis of that data as performed by a method in accordance with the present teachings. The one or more programmable processors may also be electronically coupled to a display or other output 22, for direct output of data or data analysis results to a user, or to electronic data storage 23, which may be located either at the site of the mass spectrometer system or at a remote location. The one or more programmable processors shown in FIG. 1 is/are generally operable to: receive a precursor ion chromatography/mass spectrometry spectrum and a product ion chromatography/mass spectrometry spectrum from the chromatography/mass spectrometry apparatus and to automatically perform the various instrument control, data analysis, data retrieval and data storage operations in accordance with the various methods discussed below.

Frequently, tandem mass spectra of natural samples are highly complex, with each one of many chemical components represented by peaks corresponding to a plurality of different-size fragment ions and each fragment of each original molecule represented by peaks corresponding to a plurality of charge states. If a fractionation apparatus 11 (FIG. 1) is employed to at least partially separate the chemical components of the sample prior to their introduction into a mass spectrometer 13 (FIG. 1), then a plurality of mass spectra may be acquired over time as the various components elute. In such cases, each individual mass spectrum will be reduced in complexity relative to a mass spectrum of an infused sample. Nonetheless, it is commonly found that: (i) a plurality of chemical components may co-elute at any one time; and (ii) each chemical component may be available for mass spectral analysis for only a limited duration, which may be as short as two seconds. Consequently, data-dependent analysis (DDA) is often employed in which real-time decisions regarding which ion species are to be selected for further analysis are made by software, these decisions based upon recently acquired mass spectral data.

Typically, post-data-acquisition mathematical or logical data analysis of the measured MS2 mass spectra may be subsequently carried out in order to identify compounds present in the sample and to calculate their absolute or relative abundances within the sample. The data analyses may make use of searchable mass spectral libraries in order to match MS1 precursor ions and their corresponding MS2 (or MSn) product ions to known compounds. The rate of success in identifying and quantifying the compounds during such post-acquisition analysis often depends upon the quality of the prior real-time decision making processed during the earlier data acquisition. However, the number of choices that are available for any real-time analysis decision are limited, since the various decision trees are either coded into instrument control software or are input into memory by a user during development of an analysis method.

Recently, with the advent of faster computer processors and speedier data transfer rates, the concept of real-time searching of tabulated mass spectral data or real-time algorithmic computation of fragmentation patterns has been introduced in order to better inform automated DDA decision-making (e.g., Erickson, Brian K., Julian Mintseris, Devin K. Schweppe, Jose Navarrete-Perea, Alison R. Erickson, David P. Nusinow, Joao A. Paulo, and Steven P. Gygi. “Active instrument engagement combined with a real-time database search for improved performance of sample multiplexing workflows.” Journal of proteome research 18, no. 3 (2019): 1299-1306. Schweppe, Devin K., Jimmy K. Eng, Cling Yu, Derek Bailey, Ramin Rad, Jose Navarrete-Perea, Edward L. Huttlin, Brian K. Erickson, Joao A. Paulo, and Steven P. Gygi. “Full-featured, real-time database searching platform enables fast and accurate multiplexed quantitative proteomics.”Journal of proteome research 19, no. 5 (2020): 2026-2034.) In this sense, the term “real-time” refers to performing such database consultation or algorithmic fragmentation prediction at the same time that a mass spectral experiment is in progress.

Real-time search was introduced commercially along with the launch of the ORBITRAP™ ECLIPSE™ line of mass spectrometer systems by Thermo Fisher Scientific of Waltham, Mass. USA. Real-time library searching was commercially introduced with the ORBITRAP™ IQ.-X™. Following the work of Schweppe et al., the commercial implementation permits users to submit MS2 spectra for real-time searching search by the common open-source peptide database matching program COMET. In a typical workflow employing real-time search, MS2 spectra are submitted to the search engine employing one of two methods: (1) comparison against theoretical spectra computed in real-time; or (2) comparison against previously acquired experimental spectra stored in a library. Typically, the result returned from the search engine results in a pass/fail or “go/no-go” result for a subsequent stage of data-dependent acquisition. Results from the search are typically used to control subsequent data-dependent mass spectral data acquisitions, most typically MS3 data acquisitions, that are triggered only after the real-time search or real-time computation results have been used to make a confident compound identification from an immediately preceding MS2 spectrum. The results of such analyses have shown that such a workflow increases instrument efficiency, resulting in improved performance as measured by the number and quality of quantified proteins in a tandem-mass-tags (TMT) experiment. (Schweppe et al.)

FIG. 2A is a flow diagram of a basic method 250 of performing DDA mass spectral analysis, with assistance from real-time searching. In step 252, a survey mass spectrum (MS1) may be automatically acquired. Generally, the ions that are mass analyzed in step 252 are presented to a mass analyzer in essentially un-fragmented form. Various peaks within the MS1 spectrum are automatically recognized in step 254. A number of techniques are known in the art to recognize peaks of a mass spectrum. Typically, some approximation of the center of the peak is used to identify the mass-to-charge ratio (m/z) of an ion during such peak recognition. Step 256 of the method 250 includes automatic selection of a precursor ion peak as well as isolation of an ion species that corresponds to the m/z of the selected peak for further analysis. The selection of precursor ion peaks at each iteration of step 256 may be based on mass spectral intensity, in order of decreasing intensity. In some cases, the automatic selection of precursor ion peaks may be based, at least in part, on an inclusion list that may include m/z ranges of particular interest. In subsequent iterations of step 256, an exclusion list can be used to avoid analysis of certain precursor ions, such as precursor ions that have been previously analyzed. Many other criteria have been employed to select ions for analysis. Often these criteria are combined to compromise a list of rules.

In step 258 of the method 250 (FIG. 2A), the MS1 ion species that was isolated in the prior execution of step 256 is fragmented (e.g., by collision-induced dissociation) or is otherwise reacted (e.g., by reaction with reagent ions) so as to generate a plurality of product-ion species, herein referred to as MS2 ion species. In the following step 260, the mass spectral peaks of the MS2 ion species are automatically identified and a real-time search of a listing of theoretically predicted peptide product ion species is automatically carried out by a mass spectral searching algorithm or module, herein referred to as a “search engine”.

Either one of the search engine and the theoretical peptide listing may be located either at the site of the analysis instrument or else at a site that is remote relative the analysis instrument. Communications between the site at which the analysis instrument is located and the remote site may be made through the Internet. For example, FIG. 2B depicts a currently-known system 200 of hardware components and software modules used for conducting mass spectral analyses in conjunction with real-time searching. In FIG. 2, firmware 206 of a mass spectrometer 204 communicates with computer hardware and/or software modules 202 by both submitting mass spectral data 208 for logical analysis and by receiving search results 214. The hardware and/or software includes an information routing service 210 and a search engine 212, either one or both of which may be located either locally or remotely, relative to the mass spectrometer. The search engine 212 includes the theoretically-derived peptide listing. The submitted mass spectral data 208 includes rudimentary mass-to-charge/intensity pairs of MS2 peaks, along with additional data such as the mass and charge of the MS1 precursor ion whose fragmentation generated corresponding MS2 ions.

In operation, the information routing service 210 waits to receive spectra from the instrument 204 which typically occurs after each execution of step 258 (FIG. 2A). When a spectrum is received by the service 210, the service sends the data to the search engine 212. The search engine performs the search (step 260) and returns results 214, which are then packaged and sent back to the instrument just prior to step 262. The instrument firmware processes the results and acquires data-dependent spectra (steps 262-264) for cases where the search engine returns a successful match, such as may be determined by a match score that indicates the degree of or quality of matching. As but one example, the degree of similarity between the acquired and tabulated mass spectra may be measured according to a variety of different kinds of scores, such as the dot-product between vector representations of the acquired and tabulated spectra. Steps 262-264 may be bypassed if there are no successful matches. Thus, these two steps are by dashed lines in FIG. 2A to indicate that they may not always be executed.

The search results 214 include specific m/z values that correspond to MS2 ion species that are to be isolated in step 262 and subsequently fragmented in step 264. For example, the m/z values of the search results 214 may be used to populate a mass spectrometer inclusion list that controls the looping of execution of the method 250 from step 264 back to step 262. The MS2 m/z values that are provided the mass spectrometer instrument 204 in search results 214 correspond to recognized known or potential matches of the MS1 and MS2 spectral data to known compounds in the listing that is being searched, as determined by the search engine 212. Since the confidence levels of the various matches will normally differ between matches, the search results 214 may include confidence scores in addition to the m/z values. These confidence scores may be utilized by the mass spectrometer firmware 206 to prioritize the order of MS2 ion species isolation and fragmentation that occurs during the multiple iterations of steps 262-264.

Each fragmentation that is performed in step 264 generates an MS3 spectrum that corresponds to a respective ion species isolation in step 256. Once all MS2 species of interest that correspond to a particular MS1 peak (e.g., as isolated in step 256) have been isolated (step 262) and fragmented (step 264), then, if the mass spectral signal has not been lost due to the end of elution, execution of the method 250 returns to step 256 whereby a next MS1 peak is isolated and the steps 258-264 are repeated. Otherwise, if the mass spectral signal of an elution peak has been lost but a chromatographic separation has not completed, then execution returns to step 252 and the steps 254-264 are repeated. Otherwise, the method 250 may terminate.

The workflow outlined in the method 250 of FIG. 2A works well in matching mass spectral data to lists of theoretically-derived peptide spectra, using a peptide database matching program such as COMET. Nonetheless, such a workflow is not perfectly amenable to analysis of other classes of analytes which do not exhibit predictable fragmentation patterns. In such cases—including many metabolites, lipids, and other compounds—a spectral library comprised of previously validated and curated experimental mass spectra is more useful than a predictive algorithm like COMET and can be used within a similar workflow as one would use with the predictive algorithm. Although library spectral matching has been used for offline data analysis for years, it has not been employed in the context of real-time search applications. The inventors have recognized that, within that context, an acquired spectrum's similarity to a spectrum in the library may be used to gate downstream data acquisition, much like the case of the predictive algorithm described above. The degree of similarity between the acquired and tabulated mass spectra may be measured according to a variety of different kinds of scores, such as the dot-product between vector representations of the acquired and tabulated spectra.

Regardless of whether a theoretical database listing or a mass spectral library is employed for real-time searching, situations may arise in which the returned identification of a mass spectrum is ambiguous or indeterminate. In such cases, the search may fail if scoring criteria are not met for any of the database or library entries, or if only the best-matching database or library entry is returned, even if the scores for the top several matches are all very similar to each other. Accordingly, the present inventors have recognized that it is advantageous to leverage additional information and metadata that may be embedded in the search tools to resolve such ambiguities. The inventors have further recognized that, to further increase the likelihood of obtaining a confident match, it is advantageous to allow real-time modification of data acquisition strategies based on metadata and other extra information that can be included or derived from a mass spectral library or other search engine tools.

### SUMMARY

This invention proposes embedding information in the search engine—either in a computational algorithm or in a mass spectral library—that would, in the case of ambiguous results or other conditions, not only trigger a new data-dependent scan, but also could change the parameters of the next data-dependent scan. This disclosure thus describes extensions to the conventional real-time search functionality described above that would allow a search engine to package certain kinds of metadata together with returned search results. These metadata would provide the instrument firmware with additional information and/or commands necessary to effectively rewrite the downstream data dependencies and acquire, during analysis of a sample, potentially any number, m, of MSn scans at any number, n, (i.e., as used in the “MSn” designation) of fragmentation levels, where the integers m and n are not known prior to the analysis and wherein the integer n is greater than a default maximum value. It is anticipated that this flexibility will allow the overall method to accommodate numerous and diverse workflows for different compound classes, as well as opening the door for exploration of “intelligent” data acquisition strategies.

According to a first aspect of the present teachings, a method of mass spectral analysis of a sample comprises:
isolating a first portion of a selected primary ion species generated by ionization of the sample;
generating one or more fragment ion species by fragmenting the isolated first portion of the primary ion species;
determining mass-to-charge (m/z) values of the fragment ion species;
searching a mass spectral database or a mass spectral library for a compound or compounds for which a predicted or observed m/z value of a primary ion species matches the selected primary ion species and for which one or more m/z values of fragment ion species that are predicted or observed to be generated by fragmentation of the matched primary ion species m/z value match determined fragment-ion m/z values;
determining a measure of success of the search of the mass spectral database or mass spectral library;
determining, based on the determined measure of success, whether or not to execute one or more subsequent actions during the mass spectral analysis of the sample, wherein said subsequent actions comprise altered or replacement procedures that override pre-planned default procedures; and
if it is determined to execute said one or more subsequent actions, causing a mass spectrometer to execute said one or more subsequent actions.

Some embodiments may include determining based on the determined measure of success, whether or not to block execution of one or more previously planned subsequent actions. The determination of whether to execute subsequent actions and/or the determination of whether to block execution of pre-planned actions, based on the measure of success, may be formulated in several different ways. For example, the determination may be based on whether the measure of success is greater than or less than a designated threshold value. In some embodiments, the determination may be made as the result of either a “success” or “failure” designation returned by a searching algorithm. In some embodiments, the determination may be based on whether the search of the mass spectral database returns certain keywords (e.g., names of potentially matching compounds, names of potentially matching classes of compounds, etc.) The determined measure of success may be based on standard statistical measures of confidence in any proposed matches, as may be returned by a searching algorithm.

Some embodiments may include determining to both block certain previously planned actions and to, instead, execute certain replacement actions, based on the determined measure of success. For example, planned fragmentation and subsequent fragment-ion analysis of certain previously targeted ion species may be abandoned in favor of fragmentation and subsequent fragment-ion analyses of other ion species that were not targeted prior to the analysis. Such blocking of planned or anticipated actions in favor of other unplanned replacement actions may occur, for example, when a searching algorithm finds matches to previously unexpected compounds of interest or else when a database search indicates that the fragmentation and fragment-ion analyses of the other ion species may yield improved detection or quantification of the originally targeted ion species. According to some embodiments, the fragmentation and subsequent fragment-ion analysis may be performed on ions that are matched by the search algorithm; according to some other embodiments, the fragmentation and subsequent fragment-ion analysis may be performed on observed ions for which matches were not found by the search algorithm.

In some embodiments, the fragmentation conditions used during fragmentation of the isolated first portion of the primary ion species include application of a first collision energy to the isolated first portion of the selected primary ion species and the fragmentation conditions employed during fragmentation of the isolated second portion of the primary ion species comprise application of a second collision energy, different than the first applied collision energy, to the isolated second portion of the primary ion species. In such instances, the second collision energy may be determined by consultation of the mass spectral database or mass spectral library.

In some embodiments, the fragmentation conditions used during fragmentation of the isolated first portion of the primary ion species comprise a first one of the group of techniques consisting of: resonantly-excited collision-induced dissociation (CID), linearly-accelerated ion beam type collision-induced dissociation (referred to either as “CID” or “HCD”), electron transfer dissociation (ETD), electron capture dissociation (ECD), surface-induced dissociation (SID), Infrared multiple photon dissociation (IRMPD), ultra-violet photo-dissociation (UVPD), etc. and the fragmentation conditions used during fragmentation of the isolated second portion of the primary ion species comprise a second, different one of said group of techniques.

In some embodiments, the one or more altered or replacement procedures comprise: isolating a second portion of the selected primary ion species; and subjecting the isolated second portion of the selected primary ion species to proton transfer reaction (PTR). In such instances, the one or more altered or replacement procedures may further comprise fragmenting the reaction products of the proton transfer reaction.

According to a second aspect of the present teachings, an analysis system is provided, the system comprising:
a mass spectrometer;
one or more computer hardware or software modules electrically coupled to the mass spectrometer; and
a mass spectral database or library that is accessible by the one or more computer hardware or software modules,
wherein the one or more computer hardware or software modules are configured to:
   retrieve, from the mass spectrometer, mass spectral data derived from a sample, the mass spectral data comprising mass-to-charge (m/z) values of one or more primary ions species isolated by the mass spectrometer and determined m/z values of one or more fragment ions generated by fragmentation, under first fragmentation conditions, of the one or more primary ions;
   search a mass spectral database or a mass spectral library for a compound or compounds for which a predicted or observed m/z value of a primary ion species matches an m/z value of an isolated primary ion species and for which one or more m/z values of fragment ion species that are predicted or observed to be generated by fragmentation of ions of the matched m/z value of match determined fragment-ion m/z values;
   determine a measure of success of the search of the mass spectral database or mass spectral library;
   determine, based on the determined measure of success, whether or not to execute one or more subsequent actions during the mass spectral analysis of the sample, wherein said subsequent actions comprise altered or replacement procedures that override pre-planned default procedures; and
   if it is determined to execute said one or more subsequent actions, cause the mass spectrometer to execute said one or more subsequent actions.

Accordingly, the present invention extends current capabilities of real-time search to encompass the ability for the real-time information derived from the search engine to direct downstream data acquisition. Such search-directed acquisition has the potential to push further the idea of “intelligent” data acquisition, where instrument efficiency is optimized and less instrument time is spent acquiring data that are either of poor quality or have little use for the experiment at hand.

### BRIEF DESCRIPTION OF THE DRAWINGS

The above noted and various other aspects of the present invention will become apparent from the following description which is given by way of example only and with reference to the accompanying drawings, not necessarily drawn to scale, in which:

FIG. 1 is a schematic depiction of a general mass spectrometry system;

FIG. 2A is a flow diagram of a known method of data-dependent mass spectrometric analysis employing real-time searching of a database of known or predicted peptide ions;

FIG. 2B is a schematic depiction of a conventional system employing a mass spectrometer coupled to a searchable database of theoretically-predicted peptide ions;

FIG. 3A is a flow diagram of a method of data-dependent mass spectrometric analysis in accordance with the present teachings that is configured to determine and carry out mass spectral analysis strategies employing real-time searching of either a database of theoretically-predicted ions or a mass spectral library of observed ions; and

FIG. 3B is a schematic depiction of a system, in accordance with the present teachings, that comprises a mass spectrometer, a searchable database or mass spectral library of theoretically predicted or experimentally observed ions, and control modules configured to execute the method of FIG. 3A.

### DETAILED DESCRIPTION

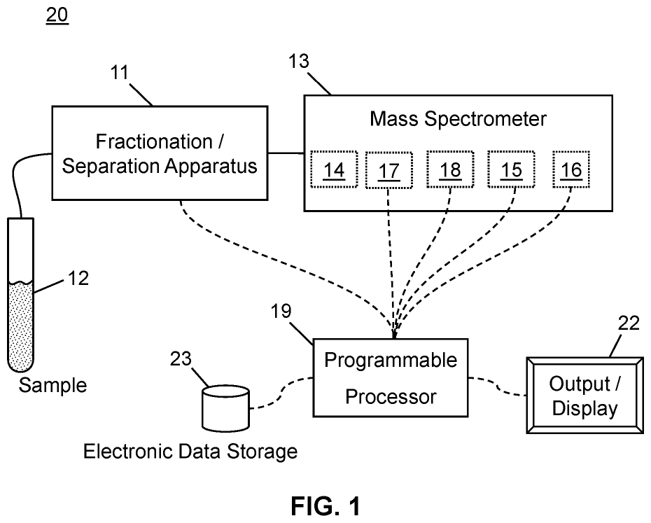

The following description is presented to enable any person skilled in the art to make and use the invention, and is provided in the context of a particular application and its requirements. Various modifications to the described embodiments will be readily apparent to those skilled in the art and the generic principles herein may be applied to other embodiments. Thus, the present invention is not intended to be limited to the embodiments and examples shown but is to be accorded the widest possible scope in accordance with the features and principles shown and described. To fully appreciate the features of the present invention in greater detail, please refer to FIGS. 1, 2A-2B, and 3A-3B in conjunction with the following description.

In the description of the invention herein, it is understood that a word appearing in the singular encompasses its plural counterpart, and a word appearing in the plural encompasses its singular counterpart, unless implicitly or explicitly understood or stated otherwise. Furthermore, it is understood that, for any given component or embodiment described herein, any of the possible candidates or alternatives listed for that component may generally be used individually or in combination with one another, unless implicitly or explicitly understood or stated otherwise. Moreover, it is to be appreciated that the figures, as shown herein, are not necessarily drawn to scale, wherein some of the elements may be drawn merely for clarity of the invention. Also, reference numerals may be repeated among the various figures to show corresponding or analogous elements. Additionally, it will be understood that any list of candidates or alternatives is merely illustrative, not limiting, unless implicitly or explicitly understood or stated otherwise.

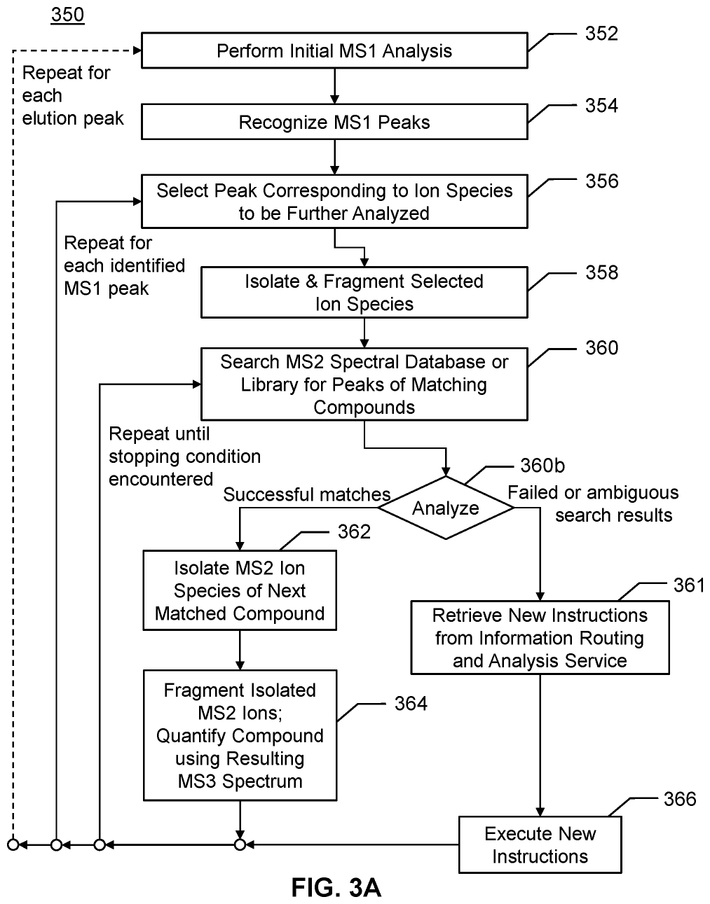

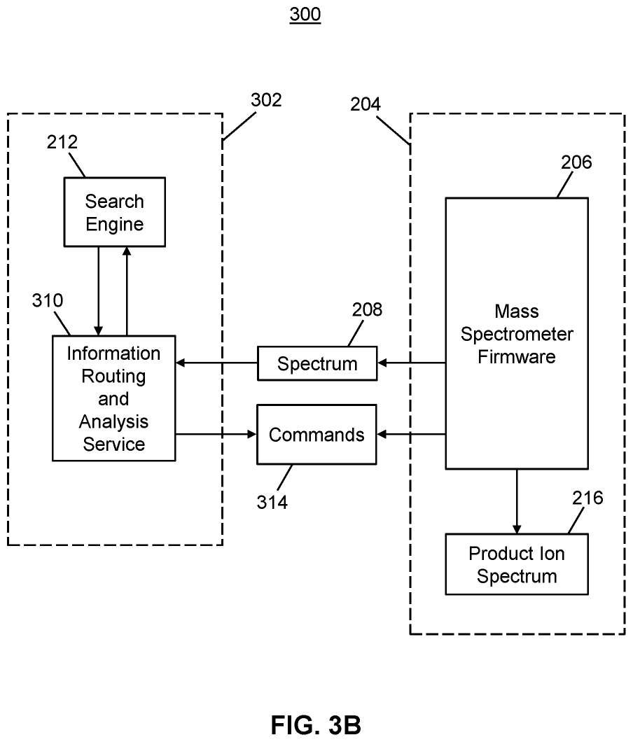

FIG. 3A is a flow diagram of a mass spectrometric data-dependent analysis (DDA) method 350 in accordance with the present teachings. FIG. 3B is a schematic depiction of a system, in accordance with the present teachings, that is configured to execute the method of FIG. 3A and that that comprises a mass spectrometer 204, a search engine 212 that includes a searchable database or mass spectral library of theoretically predicted or experimentally observed ions, and control modules 310, 206.

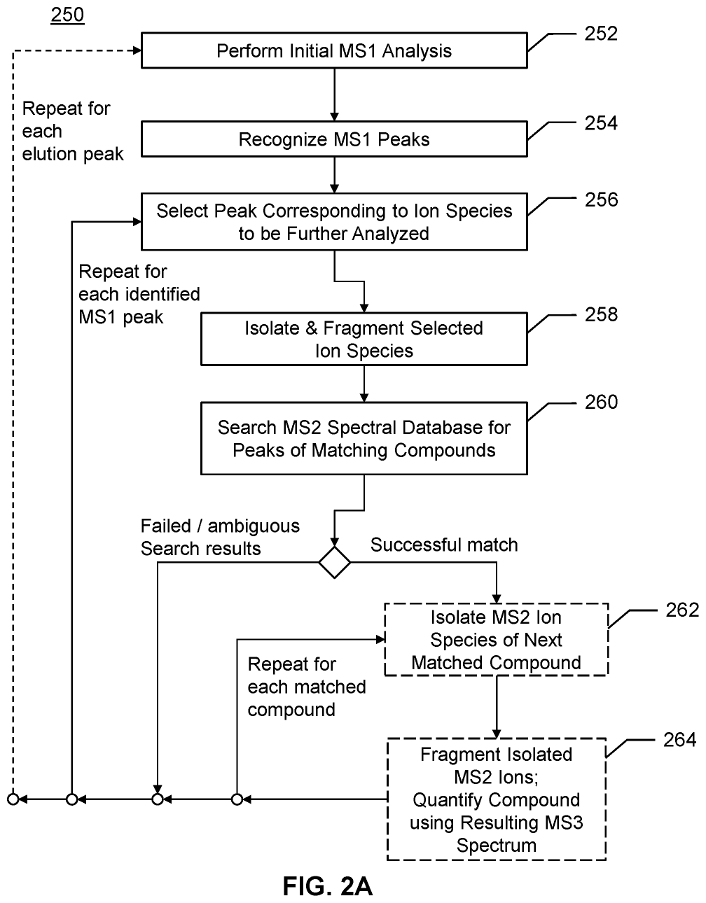

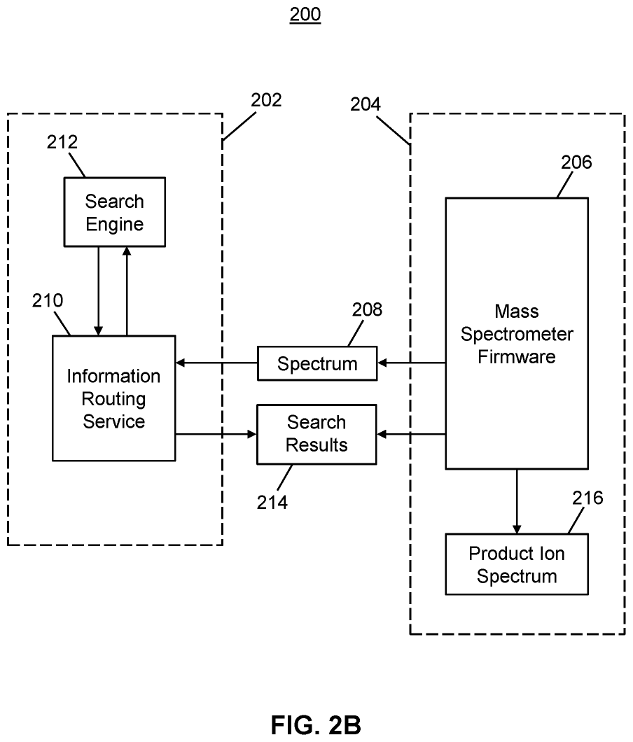

In order to emphasize the specific differences between methods of the present teachings and conventionally employed real-time data-dependent mass spectrometric data acquisition methods, the flow diagram method 350 is organized in parallel with the flow diagram of the conventional method 250. Specifically, in similarity to the flow diagram of the method 250 (FIG. 2A), the flow diagram of the method 350 (FIG. 3A) is organized so as to show MS2 data being submitted to a search engine (e.g., step 360). However, it is to be understood that the exemplary method 350 is representative of a family of methods in which the most-often-executed steps in the innermost execution loop—represented in FIG. 3A by steps 360-366—may be applied to mass spectra at any level, n, of MSn analysis, where n>1. In other words, although the illustrated step 360 of FIG. 3A specifically pertains to searching a database or library of mass spectral information for matches to peaks of an MS2 mass spectrum and then performing subsequent actions based on the results of the search, the novel methods taught herein also pertain to searching a database or library for matches to MS1, MS3, MS4, . . . mass spectra and performing subsequent actions based on the results of such searches.

Steps 352, 354, 356 and 358 of the method 350 are similar to the steps 252, 254, 256 and 258 of the method 250 (FIG. 2A) and are thus not described in detail here. The step 360 (FIG. 3A) is similar to the step 260 (FIG. 2A) but differs from step 260 in that mass spectral data 208 (FIG. 3B) is transferred to computer hardware and/or software modules 302 instead of the modules 202. The modules 302 (FIG. 3B) differ from the previously described computer hardware and/or software modules 202 (FIG. 2B) in that the modules 302 include the extra functionality of an analysis service that is configured to receive search results from the search engine 212 and, in response to the received search results, to generate and transfer certain metadata 314 back to the mass spectrometer system 204. This extra functionality is embodied in information routing and analysis service 310 that replaces the information routing service 210 of the system 200. The information routing and analysis service may be embodied in a single software or hardware module or, alternatively, may comprise an information routing software or hardware module and a separate analysis service hardware or software module. Alternatively, the information routing and analysis service functionalities could be incorporated directly into the search engine module 212.

In step 360b of the method 350 (FIG. 3A), the results of a mass spectral search (step 360) are returned from the search engine 212 to the analysis service module of component 310 (FIG. 3B). In contrast to the fashion in which the search results are handled during execution of the conventional method 250 (FIG. 2A), the search results of step 360 are not directly routed to the mass spectrometer 204. Instead, the search results are analyzed and acted upon (step 360b) by the analysis service module of component 310. The analysis step 360b is generally executed after each search. The analysis service module may assess the overall quality of search results provided by the search engine 212 and assign a confidence score to the search results based on such assessment. Based on the determined confidence score, the analysis service module may then determine to either: (i) forward the un-augmented search results 214 to the mass spectrometer as in FIG. 2B; (ii) augment the search results with additional metadata that includes mass spectrometer instructions that alter mass spectrometer settings that are to be employed during subsequent fragmentation of ions having m/z values that the search engine has identified; or (iii) replace the search results with a new set of mass spectrometer commands that reconfigures or replaces and thereby overrides all or a portion of a pre-planned default sequence of subsequent mass spectrometer operations.

If, in step 360b, the analysis service determines to execute the option (i) of simply forwarding the search results to the mass spectrometer, then execution of the method 350 branches to the default analysis steps 362 and 364, which are similar to the steps 262 and 264 of the conventional method 250. These steps may be executed when the analysis in step 360b determines, with high confidence, that a most recent search was successful and unambiguous. Otherwise, if the analysis service determines to execute either the option (ii) or the option (iii) as described above, then the execution of the method 350 branches to step 361, in which the search results and/or metadata are sent to the mass spectrometer and retrieved thereat. In this case the metadata may include altered instructions or replacement instructions that override the default analysis steps. These altered or replacement instructions are then carried out by the mass spectrometer in step 366. The steps 361 and 366 may be carried out when the analysis in step 360b determines that a most recent search was either unsuccessful or ambiguous.

Generally, the execution of the new instructions in step 366 will cause the mass spectrometer to generate new mass spectral data comprising determined m/z values of new ion species that are generated by the execution of those instructions. This newly generated mass spectral data may, itself, be submitted back to the database or library in a re-iteration of step 360 and, under such circumstances, the newly created search results are themselves analyzed in a re-iteration of step 360b. If the new analysis of the new search results in a successful match between the acquired data and an entry for a compound in the database, then steps 362 and 364 are executed after which the method 350 return to steps 356 and 358 in which a new MS1 peak is selected and isolated, respectively. Otherwise, if the new analysis of the newly generated data fails to produce a confident or unambiguous match, then either: (i) steps 361 and 366 may be executed again with yet new instructions to create yet new mass spectral data that is itself submitted for search, or (ii) if a stopping condition has been reached, then execution of the method 350 may break out of the loop of steps 360-366 with a “fail” indication. For example, the stopping condition may be a maximum permitted number of iterations of the loop of steps 360-366. The following examples illustrate a few of the ways in which the mass spectrometer operations may be altered or replaced during the execution of step 366.

### Example 1: Modification of Collision Energies

Spectra of many classes of metabolites are present in libraries under many experimental conditions, most notably numerous different values of collision energy. These values may not match what is defined in a user's data acquisition method, and so while an identification might be obtained via real-time spectral library search (step 360), the search results may not satisfy threshold scoring criteria, as determined by the search engine 212 and/or the analysis service module of component 310 (FIG. 3B). Instead of issuing a “fail” result, as would occur under conventional mass spectral analysis, that would result in no downstream data acquisition, the search engine and/or the analysis service module could, instead, survey the library spectra, compare the user's collision energy setting with those in the library, and then send metadata commands 314 that direct the instrument to acquire another spectrum of fragment ions generated at a different collision energy that more closely matches data in the library. The search engine and/or the analysis service module could possibly even direct the mass spectrometer to acquire a plurality of additional spectra, where each such spectrum corresponded to fragment ions generated at a different respective collision energy setting.

### Example 2: Modification of Activation Types

In some cases, a preset canonical activation method for general mass spectrometry analysis, collision induced dissociation (either beam type or resonance type), may not be effective at all for generating useful information for members of a compound class under study. In such cases, auxiliary mass spectral libraries having additional content, such as mass spectral data pertaining to fragment ions generated from members of the class using ultraviolet photodissociation (UVPD) could be consulted. Then, when and if collision-induced fragmentation does not yield useful information, the analysis service module may send commands 314 to the mass spectrometer that direct the instrument to acquire a fragmentation spectrum (e.g., at step 366) of a same precursor ion species that was isolated in step 358, but using UVPD instead of collision-induced fragmentation. The analysis service module, if present, may then direct the search engine 212 to consult the auxiliary database, instead of the preset database, for matches at the next iteration of step 360. This example could clearly be extended to other activation or reaction types such as electron transfer dissociation (ETD) electron capture dissociation (ECD), Surface-Induced dissociation (SID), Infrared multiple photon dissociation (IRMPD), Proton Transfer Reaction (PTR), etc. that cause fragmentation or other reaction of precursor ions. For example, a second portion of primary ions may be subjected to PTR procedure in order to generate PTR reaction product ions having charge states that are reduced relative to the charge states of the original primary ions. The reduced charge states may more closely correspond to entries in a searchable database or library. The PTR reaction product ions may then be subjected to fragmentation.

### Example 3: Modification of MSn Level, n

In some cases, a user's data acquisition method using real-time search may require, prior to triggering an MS(n+1) analysis to quantify a compound (e.g., step 364, where n+1=3), a high degree of confidence in the identification of the compound as obtained from searching observed MSn peaks (e.g., step 360, where n=2) against a library or database. In the case that the initial search returns ambiguous results, the analysis service module, if present, could survey the available spectra and find that the ambiguity could be resolved by the acquisition of an appropriate additional MS3 spectrum. The information routing and analysis module 310 could then send (at step 361) metadata commands 314 to the mass spectrometer 204 that direct the instrument to acquire the additional spectrum (step 366) before issuing a pass/fail result. In other cases, a sub-par match may need to be confirmed by acquisition of higher-level MSn spectra, such as MS4 mass spectra. Rather than acquiring MS4 spectra of every precursor ion, the search engine can direct the instrument to only acquire MS4-level spectra when it is likely to yield useful information.

The discussion included in this application is intended to serve as a basic description. The present invention is not intended to be limited in scope by the specific embodiments described herein, which are intended as single illustrations of individual aspects of the invention. Functionally equivalent methods and components are within the scope of the invention. Various other modifications of the invention, in addition to those shown and described herein will become apparent to those skilled in the art from the foregoing description and accompanying drawings. Any technical publications, patents or patent application publications mentioned herein are hereby incorporated by reference herein in their entirety.

What is claimed is:

1. A method of mass spectral analysis of a sample comprising:
isolating a first portion of a selected primary ion species generated by ionization of the sample;
generating one or more fragment ion species by fragmenting the isolated first portion of the primary ion species;
determining mass-to-charge (m/z) values of the fragment ion species;
searching a mass spectral database or a mass spectral library for a compound or compounds for which a predicted or observed m/z value of a primary ion species matches the m/z value of the selected primary ion species and for which one or more m/z values of fragment ion species that are predicted or observed to be generated by fragmentation of ions having the matched m/z value match determined fragment-ion m/z values;
determining a measure of success of the search of the mass spectral database or mass spectral library;
determining, based on the determined measure of success, whether or not to execute one or more subsequent actions during the mass spectral analysis of the sample, wherein said subsequent actions comprise altered or replacement procedures that override pre-planned default procedures; and
if it is determined is to execute said one or more subsequent actions, causing a mass spectrometer to execute said one or more subsequent actions.

2. A method of mass spectral analysis as recited in claim 1, wherein the one or more altered or replacement procedures comprise isolating and fragmenting a second portion of the selected primary ion species using fragmentation conditions that differ from fragmentation conditions used during fragmentation of the isolated first portion of the primary ion species.

3. A method of mass spectral analysis as recited in claim 2, wherein the fragmentation conditions used during fragmentation of the isolated first portion of the primary ion species include application of a first collision energy to the isolated first portion of the selected primary ion species and the fragmentation conditions employed during fragmentation of the isolated second portion of the primary ion species comprise application of a second collision energy, different than the first applied collision energy, to the isolated second portion of the primary ion species.

4. A method of mass spectral analysis as recited in claim 3, wherein the second collision energy is determined by consultation of the mass spectral database or mass spectral library.

5. A method of mass spectral analysis as recited in claim 2,
wherein the fragmentation conditions used during fragmentation of the isolated first portion of the primary ion species comprise a first one of the group of techniques consisting of: resonant excitation collision-induced dissociation (CID), linearly-accelerated ion beam type collision-induced dissociation (HCD), electron transfer dissociation (ETD), electron capture dissociation (ECD), surface-induced dissociation (SID) Infrared multiple photon dissociation and ultra-violet photo-dissociation (UVPD) (IRMPD); and
wherein the fragmentation conditions used during fragmentation of the isolated second portion of the primary ion species comprise a second, different one of said group of techniques.

6. A method of mass spectral analysis as recited in claim 1, wherein the one or more altered or replacement procedures comprise:
isolating a second portion of the selected primary ion species; and
subjecting the isolated second portion of the selected primary ion species to proton transfer reaction (PTR).

7. A method of mass spectral analysis as recited in claim 1, wherein the one or more altered or replacement procedures comprise:
fragmenting reaction products of the proton transfer reaction.

8. A method of mass spectral analysis as recited in claim 1, wherein the one or more altered or replacement procedures comprise acquiring, during analysis of the sample, a number, n, of fragmentation levels, where the integer n is not known prior to the analysis and is greater than a default maximum value.

9. An analysis system comprising:
a mass spectrometer;
one or more computer hardware or software modules electrically coupled to the mass spectrometer; and
a mass spectral database or library that is accessible by the one or more computer hardware or software modules,
wherein the one or more computer hardware or software modules are configured to:
retrieve, from the mass spectrometer, mass spectral data derived from a sample, the mass spectral data comprising mass-to-charge (m/z) values of one or more primary ions species isolated by the mass spectrometer and determined m/z values of one or more fragment ions generated by fragmentation, under first fragmentation conditions, of the one or more primary ions;
search a mass spectral database or a mass spectral library for a compound or compounds for which a predicted or observed m/z value of a primary ion species matches an m/z value of an isolated primary ion species and for which one or more m/z values of fragment ion species that are predicted or observed to be generated by fragmentation of ions of the matched m/z value of match determined fragment-ion m/z values;
determine a measure of success of the search of the mass spectral database or mass spectral library;
determine, based on the determined measure of success, whether or not to execute one or more subsequent actions during the mass spectral analysis of the sample, wherein said subsequent actions comprise altered or replacement procedures that override pre-planned default procedures; and
if it is determined to execute said one or more subsequent actions, cause the mass spectrometer to execute said one or more subsequent actions.

10. An analysis system as recited in claim 9, wherein the one or more computer hardware or software modules are configured to execute subsequent actions that include altered or replacement procedures that comprise isolating and fragmenting the primary ion species using second fragmentation conditions that differ from the first fragmentation conditions.

11. An analysis system as recited in claim 10, wherein the second fragmentation conditions comprise a second collision energy that differs from a first collision energy of the first fragmentation conditions.

12. An analysis system as recited in claim 11, wherein the second collision energy is determined by consultation of the mass spectral database or mass spectral library.

13. An analysis system as recited in claim 10
wherein the first fragmentation conditions comprise utilization of a first one of the group of techniques consisting of: resonant excitation collision-induced dissociation (CID), linearly-accelerated ion beam type collision-induced dissociation (HCD), electron transfer dissociation (ETD), electron capture dissociation (ECD), surface-induced dissociation (SID) Infrared multiple photon dissociation and ultra-violet photo-dissociation (UVPD) (IRMPD); and
wherein the second fragmentation conditions comprise utilization of a second, different one of said group of techniques.

14. An analysis system as recited in claim 9, wherein the pre-planned default procedure comprises fragmentation of additional primary ions derived from the sample and the one or more computer hardware or software modules are configured to:
execute a replacement procedure that replaces the fragmentation of the additional primary ions derived from the sample by proton transfer reaction of the additional primary ions derived from the sample.

15. An analysis system as recited in claim 14, wherein the replacement procedure further comprises fragmentation of products of the proton transfer reaction.

16. An analysis system as recited in claim 9, wherein the one or more computer hardware or software modules are configured to execute subsequent actions that include altered or replacement procedures that comprise acquiring, during analysis of the sample, a number, n, of fragmentation levels, where the integer n is not known prior to the analysis and is greater than a default maximum value.
